(19) United States
(12) Patent Application Publication
(10) Pub. No.: US 2023/0056965 A1
(43) Pub. Date: Feb. 23, 2023

(54) DYNAMIC MULTI-STREAM DEPLOYMENT PLANNER

(71) Applicant: INTERNATIONAL BUSINESS MACHINES CORPORATION, Armonk, NY (US)

(72) Inventors: Rafal Konik, Oronoco, MN (US); Jingdong SUN, Rochester, MN (US); Jessica R. Eidem, Rochester, MN (US); Roger Mittelstadt, Byron, MN (US)

(21) Appl. No.: 17/409,406

(22) Filed: Aug. 23, 2021

(51) Int. Cl. G06F 8/60; H04L 29/08

(52) U.S. Cl. CPC G06F 8/60; H04L 67/34

(57) ABSTRACT

A computer deploys one or more stream instances, where each one of the one or more stream instances having an instance deployment manager to control one or more operators of the each of the one or more stream instances. The computer causes the instance deployment manager to collect information of one or more operators in the one or more stream instances The computer may determine a deployment plan for the one or more stream instances based on the information and send one or more instructions to the instance deployment manager to optimize performance of at least one of the one or more stream instances, based on the deployment plan.

### BACKGROUND

The present invention relates, generally, to the field of computing, and more particularly to optimization of multi-stream deployment.

Deployment of a software program or service is a group of activities that make a software system available for use. The general deployment process consists of several interrelated activities with possible transitions between them. These activities may occur at the producer side or at the consumer side or both. Due to the variety of the software systems, the precise processes or procedures within each activity may not be uniquely defined. Therefore, deployment of a software program or service is typically customized according to specific requirements or characteristics. Typically, multiple deployments may be performed on a single system that are frequently divided into stream instances by utilizing container orchestration system.

The container orchestration system, such as Kubernetes, enables automating computer application deployment, scaling, management and operations of application containers across clusters of hosts.

### SUMMARY

According to one embodiment, a method, computer system, and computer program product for dynamic stream deployment planner is provided. The present invention may include a computer that deploys one or more stream instances, where each one of the one or more stream instances having an instance deployment manager to control one or more operators of the each of the one or more stream instances. The computer causes the instance deployment manager to collect information of one or more operators in the one or more stream instances The computer may determine a deployment plan for the one or more stream instances based on the information and send one or more instructions to the instance deployment manager to optimize performance of at least one of the one or more stream instances, based on the deployment plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary stream deployment management block diagram according to at least one embodiment;

FIG. 3 is an operational flowchart illustrating a stream deployment manager process according to at least one embodiment;

FIG. 4 is an operational flowchart illustrating a stream deployment planner process according to at least one embodiment;

FIG. 5 is a block diagram of internal and external components of computers and servers depicted in FIG. 1 according to at least one embodiment;

FIG. 6 depicts a cloud computing environment according to an embodiment of the present invention; and

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to optimization of multi-stream deployment. The following described exemplary embodiments provide a system, method, and program product to, among other things, use an instance deployment manager (IDM) in each of the available stream instances that collects deployment data in real time and forwards it to a stream deployment planner that determines an optimal deployment plan and controls all of the available IDMs to execute the plan. Therefore, the present embodiment has the capacity to improve the technical field of deployment of a new program or service when multiple stream instances are utilized by collecting deployment data and determining an optimal plan for a deployment of the software.

As previously described, deployment of a software program or service is a group of activities that make a software system available for use. The general deployment process consists of several interrelated activities with possible transitions between them. These activities may occur at the producer side or at the consumer side or both. Due to the variety of the software systems, the precise processes or procedures within each activity may not be uniquely defined. Therefore, deployment of a software program or service is typically customized according to specific requirements or characteristics. Typically, multiple deployments may be performed on a single system that are frequently divided into stream instances by utilizing container orchestration system.

Typically, in a cloud infrastructure, in order to enable scaling and increase stability, a plurality of containers or virtual machines are used in order to enable various services on the same cluster of machines. In order to improve hardware utilization, a stream approach is used, where a stream instance is a stream of a specific data that is used by different programs (operators) that analyze the data stream in order to provide specific information to the user or to another operator. Deployment or scaling of the stream instances on the same machine or cluster my generate an overload to the hardware that manages the stream instances. As such, it may be advantageous to, among other things, implement a system that collects load and performance related parameters from each of the operators in a stream instance and forwards it to a stream deployment planner that aggregates all of the data that is related to a specific machine, cluster, database or operator and dynamically generates a deployment plan that enables effective resource utilization and the deployment plan may be stored and used when the same stream instance is deployed in another instance.

According to one embodiment, an instance deployment manager may be added to each stream instance to analyze resource load of a machine by collected data from each operator within the stream and send it to a stream deployment planner. The stream deployment planner may analyze the received information from multiple stream instances and determine and deploy a plan that enables each of the streams to run in an optimal setting by adjusting the hardware settings related to each of the stream requirements during runtime.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to collect resource information during deployment of a new program of each stream instance and determine a deployment plan based on the resource information using instance deployment managers and stream deployment planner components.

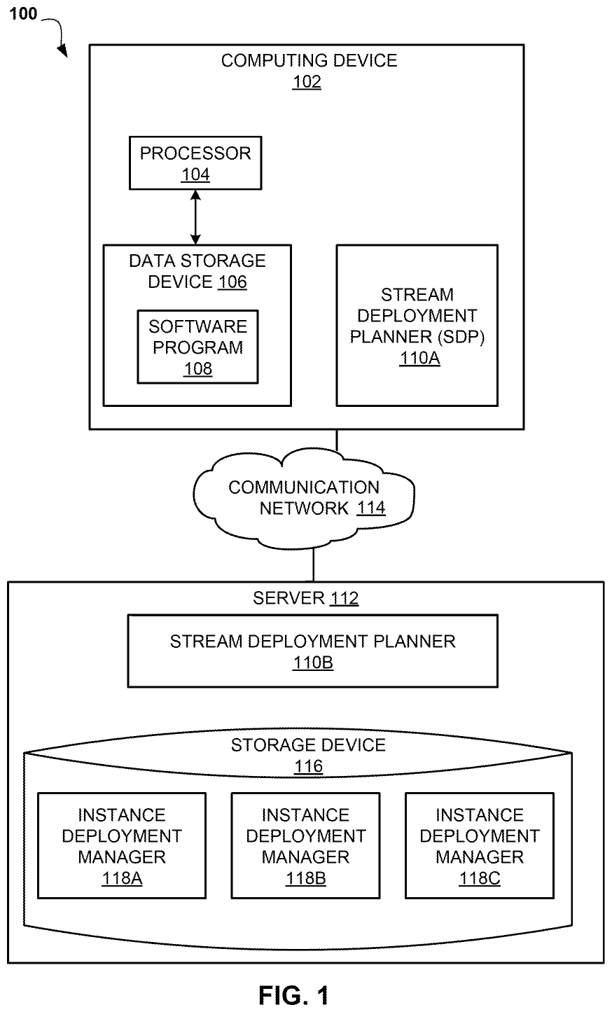

Referring to FIG. 1, an exemplary networked computer environment 100 is depicted, according to at least one embodiment. The networked computer environment 100 may include a computing device 102 and a server 112 interconnected via a communication network 114. According to at least one implementation, the networked computer environment 100 may include a plurality of computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

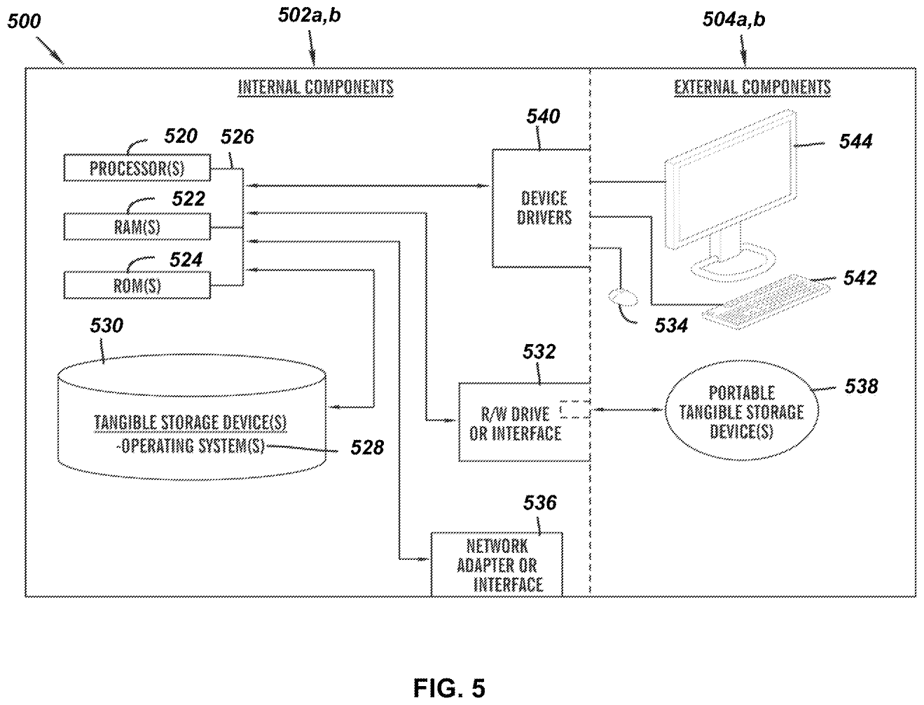

Computing device 102 may include a processor 104 and a data storage device 106 that is enabled to host and run a software program 108 and a stream deployment planner (SDP) 110A and communicate with the server 112 via the communication network 114, in accordance with one embodiment of the invention. Computing device 102 may be, for example, a netbook, a laptop computer, a tablet computer, a desktop computer, a virtual machine, a mobile device, a telephone, a personal digital assistant, or any type of computing device capable of running a program and accessing a network. As will be discussed with reference to FIG. 5 the computing device 102 may include internal components 502a and external components 504a, respectively.

The server computer 112 may be a laptop computer, netbook computer, personal computer (PC), a desktop computer, a virtual machine or any programmable electronic device or any network of programmable electronic devices capable of hosting and running a stream deployment planner (SDP) 110B and a storage device 116 that may be used to maintain multiple streams that may be monitored using an instance deployment manager (IDM) 118A-118C and communicating with the computing device 102 via the communication network 114, in accordance with embodiments of the invention. According to one of the embodiments, each IDM 118A-118C may collect information on each operator within the stream, send it to the SDP and control the resources of the stream instance based on instructions received from the SDP. As will be discussed with reference to FIG. 5, the server computer 112 may include internal components 502b and external components 504b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

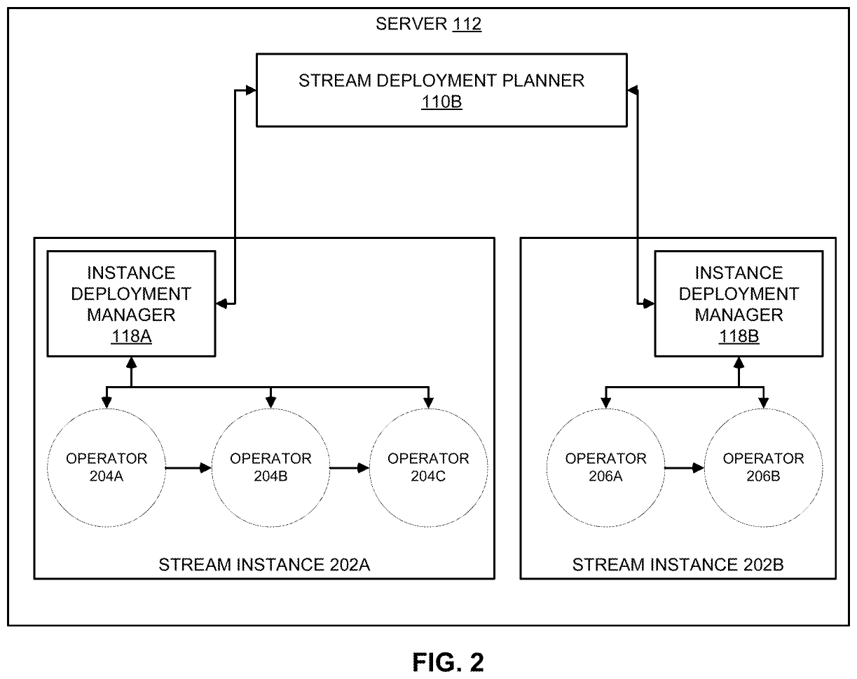

According to the present embodiment, the stream deployment planner 110A, 110B may be a program capable of controlling one or more IDMs 118A-118C running on each stream instance and after analyzing live operator resource data identify an optimal deployment plan. The interaction between IDMs 118A-118C and SDP 110A, 110B is explained in further detail below with respect to FIG. 2.

Referring now to FIG. 2, an exemplary stream deployment management block diagram according to at least one embodiment is depicted. According to an example embodiment, any deployed stream instance, such as stream instance 202A and stream instance 202B, may have a plurality of operators that utilize the associated data stream. For example, operators 204A-204C utilize the stream instance 202A, when operators 206A-206B utilize stream instance 202B. According to at least one embodiment, each stream instance during deployment is accompanied by an IDM, such as IDM 118A for stream instance 202A and IDM 118B for stream instance 202B. Each IDM may act as a specific operator within a specific stream to collect resource utilization and efficiency data for each operator and send the aggregated information to the stream deployment planner 110A, 110B in order to analyze the aggregated information and determine an optimal stream deployment plan that allows maximum throughput of data by utilizing minimum available resources. According to an example embodiment, the instance deployment manager may measure data throughput through each operator, memory and core utilization of each operator during runtime.

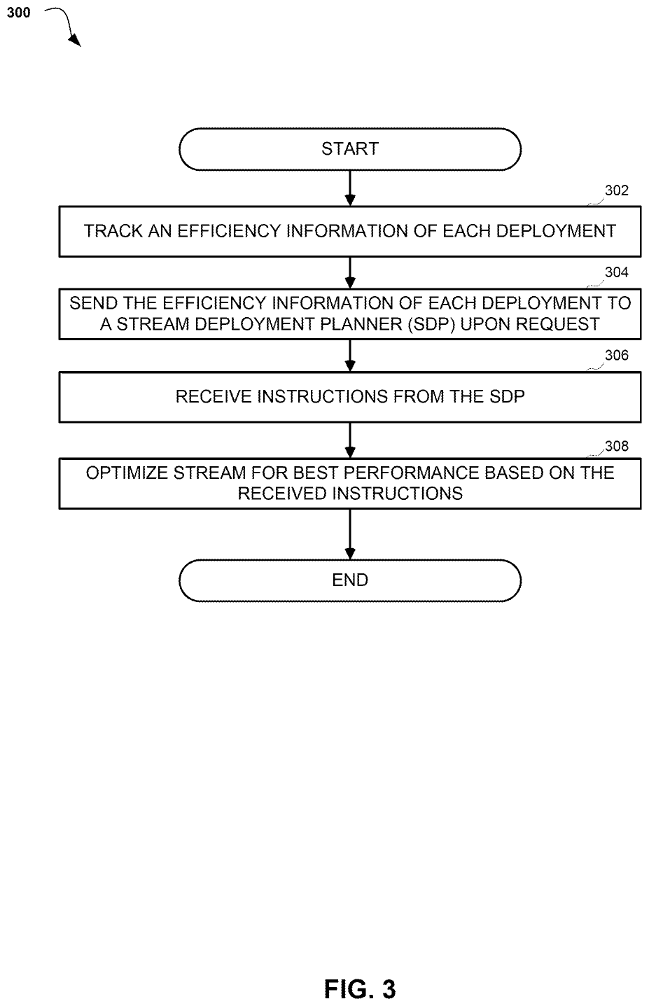

Referring now to FIG. 3, an operational flowchart illustrating an instance deployment manager process 300, according to at least one embodiment is depicted. At 302, the instance deployment manager (IDM) 118A, 118B tracks efficiency information of each deployment. According to an example embodiment, the SDP 118A, 118B may determine efficiency of each stream instance by tracking deployment rules, results, operators, and tuples along with each of the running operators resource information, such as memory utilization, CPU and core load parameters associated with each operator. The aggregated information, coupled with the efficiency and performance information may be used to determine optimal deployment plans that are used and shared with other similar stream instance deployments for machine load and performance optimization.

Next, at 304, the IDM 118A, 118B sends the efficiency information of each deployment to a stream deployment planner (SDP) upon request. According to an example embodiment, the SDP 118A, 118B may send the collected information related to efficiency of the stream deployment to the SDP 110A, 110B that aggregates information from all of the streams and may analyze it in order to develop and identify the efficient settings for operation of multiple streams on a single machine or a cluster of machines that enable the stream instances.

Then, at 306, the IDM 118A, 118B receives instructions from the SDP. According to an example embodiment, the SDP 118A, 118B may receive instructions to optimize stream instance performance, such as expand or change a number of active cores for the stream instance, adjust available cache memory, or optimize one or more operators in a stream instance. In another embodiment, the IDM 118A, 118B may receive an instruction to suspend or resume operation of one or more operators of the stream instance.

Next, at 308, the IDM 118A, 118B optimizes the stream for best performance based on the received instructions. According to an example embodiment, the SDP 118A, 118B may actively change the settings of each of the running operators based on the received instructions, such as relocate the operator to a different machine or a cluster, change the amount of operating memory used by each of the operators and stop or resume operation of an existing operator.

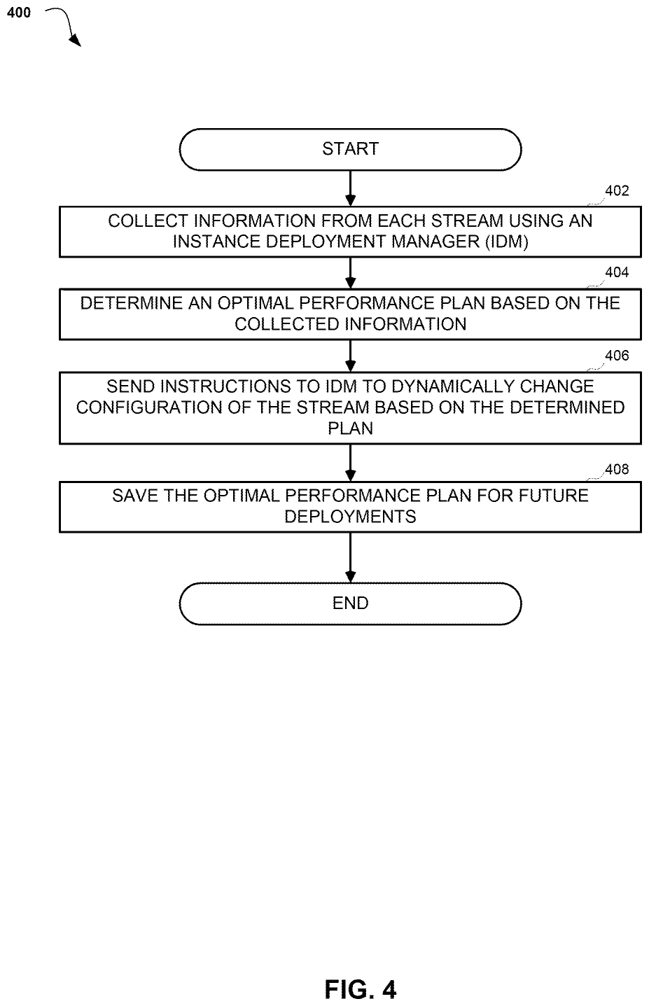

Referring now to FIG. 4, an operational flowchart illustrating a stream deployment planner process 400, according to at least one embodiment is depicted. At 402, the SDP 110A, 110B collects information from each stream using an instance deployment manager (IDM). According to an example embodiment, the SDP 118A, 118B may send an instruction to IDMs (e.g., IDM 118A, 118B) that in response to transfer information related to efficiency of each deployment during a runtime of the stream instance.

Next, at 404, the IDM 118A, 118B determines an optimal performance plan based on the collected information. According to an example embodiment, the SDP 110A, 110B may evaluate the received information and based on a number of stream instances running on a machine, available memory, CPU utilization or other measurable performance factors determine an optimal memory, processing power and other hardware or software requirements for the optimal output of each of the stream instances. In another embodiment, the IDM 118A, 118B may determine the best performance plan by incrementally updating, during runtime, the settings in order to receive the highest throughput of the operators in the stream instance. In further embodiments, the IDM 118A, 118B may identify the operators of the stream and search in the saved plans repository for a similar or identical stream settings and apply the saved plan settings to the current stream.

Then, at 406, the IDM 118A, 118B sends instructions to IDM to dynamically change configuration of the stream based on the determined plan. According to an example embodiment, the SDP 110A, 110B may send instructions to IDM 118A, 118B that adjust a number of active cores/processors or memory in order to improve overall throughput of the stream. For example, when the plan of the SDP 110B states that the stream instance 202A requires 6 active cores and only 4 cores are currently utilized by the stream instance 202A, the SDP 110A, 110B may send an instruction to the instance deployment manager 118A to increase the number of active cores to 6 for the stream instance 202A.

Next, at 408, the IDM 118A, 118B saves the optimal performance plan for future deployments . According to an example embodiment, the SDP 110A, 110B may save the optimal performance plan for each stream instance in a performance plan repository such as in a data storage device 102 or storage device 116 (FIG. 1) and apply the plan when a similar stream is deployed on other machine or cluster. According to an example embodiment, the plan may include instructions to allocate a predetermined amount of memory, a predetermined minimum processor power, such as minimum amount of active cores required for the stream instance to operate, what operators to suspend or enable when the processing power or memory usage reaches a specific value.

It may be appreciated that FIGS. 3-4 provide only an illustration of one implementation and does not imply any limitations with regard to how different embodiments may be implemented. Many modifications to the depicted environments may be made based on design and implementation requirements. According to an alternative embodiment, the SDP 110A, 110B may determine and save a deployment plan of a minimum resources that allows the stream instance to operate.

FIG. 5 is a block diagram 500 of internal and external components of the computing device 102 and the server 112 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The computing device 102 and the server 112 may include respective sets of internal components 502a,b and external components 504a,b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the software program 508 and the stream deployment planner 110A in the computing device 102, and the stream deployment planner 110B in the server 112 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the SDP 110A, 110B, can be stored on one or more of the respective portable computer-readable tangible storage devices 538, read via the respective R/W drive or interface 532, and loaded into the respective hard drive 330.

Each set of internal components 502a,b also includes network adapters or interfaces 536 such as a TCP/IP adapter cards, wireless Wi-Fi interface cards, or 3G or 4G wireless interface cards or other wired or wireless communication links. The software program 108 and the SDP 110A in the computing device 102 and the SDP 110B in the server 112 can be downloaded to the computing device 102 and the server 112 from an external computer via a network (for example, the Internet, a local area network or other, wide area network) and respective network adapters or interfaces 536. From the network adapters or interfaces 536, the software program 108 and the SDP 110A in the computing device 102 and the SDP 110B in the server 112 are loaded into the respective hard drive 530. The network may comprise copper wires, optical fibers, wireless transmission, routers, firewalls, switches, gateway computers and/or edge servers.

Each of the sets of external components 504a,b can include a computer display monitor 544, a keyboard 542, and a computer mouse 534. External components 504a,b can also include touch screens, virtual keyboards, touch pads, pointing devices, and other human interface devices. Each of the sets of internal components 502a,b also includes device drivers 340 to interface to computer display monitor 544, keyboard 542, and computer mouse 534. The device drivers 540, R/W drive or interface 532, and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

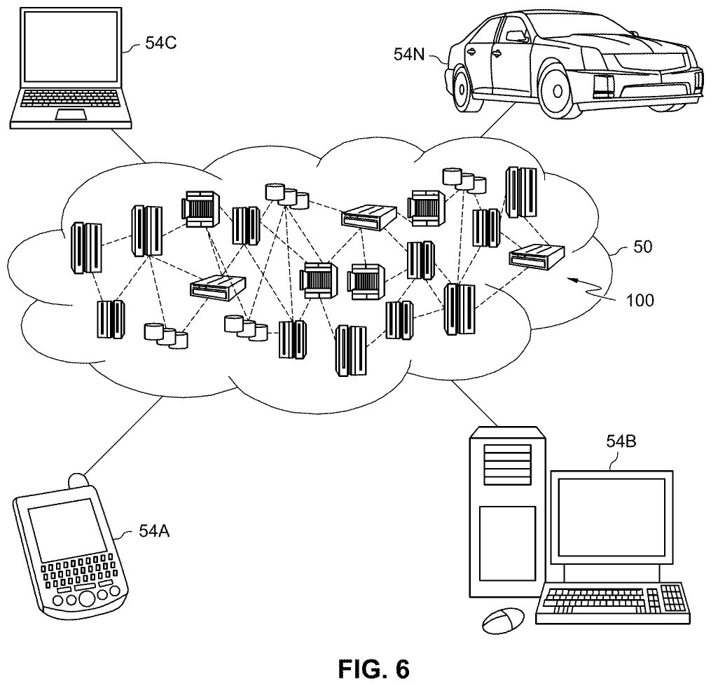

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 100 and cloud computing environment 50 can communicate with any type of computerized device over any type of network and/or network addressable connection (e.g., using a web browser).

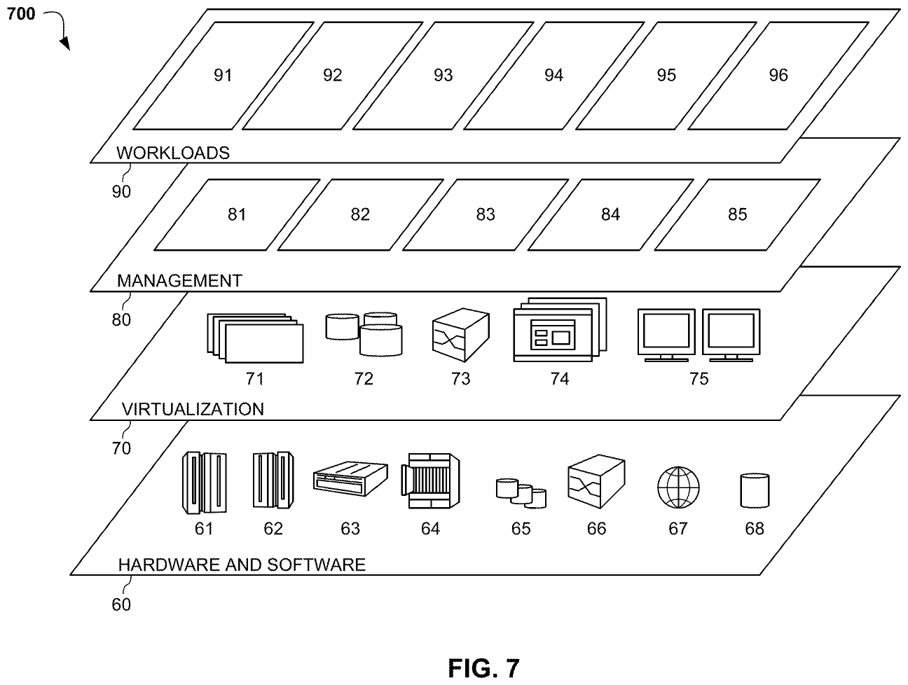

Referring now to FIG. 7, a set of functional abstraction layers 500 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and stream deployment planning 96. Stream deployment planning 96 may relate to causing an instance deployment manager operator of each stream to collect and send information related to the efficiency of the deployment, analyze the information and, based on the information, identify and deploy a plan that enables the stream to run in an optimal setting.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for dynamic stream deployment planner, the method comprising:
deploying one or more stream instances, wherein each one of the one or more stream instances having an instance deployment manager to control one or more operators of each stream instance;
causing the instance deployment manager to collect information of one or more operators in each stream instance;
determining a deployment plan for the one or more stream instances based on the information; and
sending one or more instructions to the instance deployment manager to optimize performance of at least one of the one or more stream instances based on the deployment plan.

2. The method of claim 1, further comprising:
saving the deployment plan in a performance plan repository.

3. The method of claim 1, wherein the information comprises a memory usage and a CPU usage of the one or more operators of the one or more stream instances.

4. The method of claim 1, wherein the deployment plan comprises instructions to optimize a throughput of the one or more stream instances.

5. The method of claim 1, wherein the one or more instructions comprise an instruction to suspend at least one of the one or more operators.

6. The method of claim 1, wherein determining the deployment plan for the one or more stream instances further comprises sending instructions to incrementally update, during runtime, settings of the one or more stream instances to receive a highest throughput of the one or more operators of the one or more stream instances.

7. The method of claim 1, wherein determining the deployment plan identifies a minimum resource value that allows one or more of the stream instances to operate.

8. A computer system for dynamic stream deployment planner, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
deploying one or more stream instances, wherein each one of the one or more stream instances having an instance deployment manager to control one or more operators of each stream instance;
causing the instance deployment manager to collect information of one or more operators in each stream instance;
determining a deployment plan for the one or more stream instances based on the information; and
sending one or more instructions to the instance deployment manager to optimize performance of at least one of the one or more stream instances, based on the deployment plan.

9. The computer system of claim 8, further comprising:
saving the deployment plan in a performance plan repository.

10. The computer system of claim 8, wherein the information comprises a memory usage and a CPU usage of the one or more operators of the one or more stream instances.

11. The computer system of claim 8, wherein the deployment plan comprises instructions to optimize a throughput of the one or more stream instances.

12. The computer system of claim 8, wherein the one or more instructions comprise an instruction to suspend at least one of the one or more operators.

13. The computer system of claim 8, wherein determining the deployment plan for the one or more stream instances further comprises sending instructions to incrementally update, during runtime, settings of the one or more stream instances to receive a highest throughput of the one or more operators of the one or more stream instances.

14. The computer system of claim 8, wherein determining the deployment plan identifies a minimum resource value that allows one or more of the stream instances to operate.

15. A computer program product for dynamic stream deployment planner, the computer program product comprising:
one or more computer-readable tangible storage medium and program instructions stored on at least one of the one or more tangible storage medium, the program instructions executable by a processor, the program instructions comprising:
program instructions to deploy one or more stream instances, wherein each one of the one or more stream instances having an instance deployment manager to control one or more operators of each stream instance;
program instructions to cause the instance deployment manager to collect information of one or more operators in each stream instance;
program instructions to determine a deployment plan for the one or more stream instances based on the information; and
program instructions to send one or more instructions to the instance deployment manager to optimize performance of at least one of the one or more stream instances, based on the deployment plan.

16. The computer program product of claim 15, further comprising:
program instructions to save the deployment plan in a performance plan repository.

17. The computer program product of claim 15, wherein the information comprises a memory usage and a CPU usage of the one or more operators of the one or more stream instances.

18. The computer program product of claim 15, wherein the deployment plan comprises instructions to optimize a throughput of the one or more stream instances.

19. The computer program product of claim 15, wherein the one or more instructions comprise an instruction to suspend at least one of the one or more operators.

20. The computer program product of claim 15, wherein program instructions to determine the deployment plan for the one or more stream instances further comprises program instructions to send instructions to incrementally update, during runtime, settings of the one or more stream instances to receive a highest throughput of the one or more operators of the one or more stream instances.
